(19) United States
(12) Patent Application Publication
(10) Pub. No.: US 2008/0074061 A1
(43) Pub. Date: Mar. 27, 2008

(54) CIRCUIT AND METHOD FOR DRIVING LIGHT SOURCE

(75) Inventors: Leaf Chen, Taipei City (TW); Chin-Fa Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: BEYOND INNOVATION TECHNOLOGY CO., LTD., Taipei City (TW)

(21) Appl. No.: 11/565,627

(22) Filed: Dec. 1, 2006

(30) Foreign Application Priority Data
Sep. 21, 2006 (TW) 95134927

(51) Int. Cl. H05B 39/04

(52) U.S. Cl. 315/309

(57) ABSTRACT

A driving circuit for a light source is provided. The circuit is suitable for a light source with a plurality of light emitting diodes (LED). The circuit includes a first pulse width modulation (PWM) unit and a power conversion unit. The first PWM unit generates a first PWM signal. The power conversion unit generates a driving voltage signal for controlling the light source to perform forward bias operation or reversed bias operation according to the duty cycle of the first PWM signal.

### CROSS-REFERENCE TO RELATED APPLICATION

This application claims the priority benefit of Taiwan application serial no. 95134927, filed Sep. 21, 2006. All disclosure of the Taiwan application is incorporated herein by reference.

### BACKGROUND OF THE INVENTION

1. Field of the Invention

The present invention relates to a driving circuit and a method thereof. More particularly, the present invention relates to a driving circuit capable of maintaining the operation temperature of at a light emitting diode (LED) and a method thereof.

2. Description of Related Art

Light emitting diode (LED) is a semiconductor device which is fabricated with semiconductor material of the III-V groups of elements compound. Such semiconductor material has the electricity/light conversion characteristics. More specifically, when a current is supplied to such semiconductor material, electrons and holes in the material combine and release excess energy as light to achieve light emitting effect.

Since the light emission of a LED is not thermo luminescence or discharge luminescence, but belongs to cold luminescence, thus, the lifespan of a LED can be up to 100,000 hours and more, and no idling time is required. Besides, since LED device has such advantages as quick responds (about 10⁻⁹ sec), small volume, lower power consumption, low contamination (no mercury), high reliability, suitability for mass production etc, it can be applied broadly. However, heat radiation has been the one major problem which affects the performance of a LED.

To resolve the heat radiation problem of LED, various techniques have been proposed by different manufacturers. FIG. 1 illustrates a conventional light emitting diode (LED) module with heat dissipation structure. Referring to FIG. 1, a mechanical heat dissipation technique is adopted in the LED module 100. The LED module 100 includes a plurality of LEDs 102 arranged adjacently. In addition, a metal plate 104 is disposed between every two adjacent LEDs 102 as heat dissipation mechanism.

Even though the structure illustrated in FIG. 1 can dissipate the heat generated during the operation of the LED module 100, however, the speed of heat dissipation thereof is limited by the thermoconductivity of the material; thus, such method cannot be used in a system with high operation speed. Moreover, the conventional structure may increase hardware cost and system volume.

### SUMMARY OF THE INVENTION

Accordingly, the present invention is directed to a driving circuit for a light source capable of maintaining the operation temperature of a light emitting diode (LED) by controlling the LED to perform forward bias operation or reversed bias operation.

The present invention further provides a driving method for a light source to provide efficient heat dissipation for a LED.

The driving circuit in the present invention is suitable for a light source having a plurality of LEDs. The circuit includes a first PWM unit and a power conversion unit. The first PWM unit generates a first PWM signal, and the power conversion unit generates a driving voltage signal according to the first PWM signal for controlling the operation of the light source to be forward bias operation or reversed bias operation, so as to stabilize the operation temperature of the light source.

According to another aspect of the present invention, a driving circuit suitable for a light source with a plurality of LEDs is provided. According to the method, the LEDs are controlled to perform forward bias operation during a first time period so that the light source works normally. In addition, the LEDs are controlled to perform reversed bias operation during a second time period so that the light source performs heat dissipation function.

A PWM signal is further generated, and during the first time period, the duty cycle of the PWM signal is controlled to be more than 50% in order to generate a driving voltage signal at a first level for driving the light source. The duty cycle of the PWM signal is controlled to be less than 50% during the second time period in order to generate a driving voltage signal at a second level so that the light source performs heat dissipation, wherein the second level is lower than the first level.

The present invention further provides a LED driving circuit including a power conversion unit and a control unit. Wherein the power conversion unit is coupled to an input voltage and converts the input voltage into an output voltage for driving a LED module according to a control signal. The control unit generates the control signal for controlling the LED module to perform forward bias operation and reversed bias operation alternatively.

A LED operates normally under forward bias and performs heat dissipation function under reversed bias, thus, heat dissipation can be performed efficiently to the LED without additional hardware in the present invention.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a conventional light emitting diode (LED) module with heat dissipation structure.

FIG. 2 illustrates the carrier movement in a LED when the LED performs forward bias operation.

FIG. 3 illustrates the carrier movement in a LED when the LED performs reversed bias operation.

FIG. 4A is a block diagram of a driving circuit for a light source according to a first exemplary embodiment of the present invention.

FIGS. 4B and 4C are block diagrams illustrating the internal circuit of the power conversion unit 402 according to the first exemplary embodiment of the present invention.

FIG. 5 is a circuit diagram of a power conversion unit according to the first exemplary embodiment of the present invention.

FIG. 6 is a timing diagram of the PWM signal required by the power conversion unit in FIG. 5 for generating a driving voltage signal.

FIG. 7 is a timing diagram of PWM signal and driving voltage signal.

FIG. 8 is a block diagram of a driving circuit for a light source according to a second exemplary embodiment of the present invention.

FIGS. 9A and 9B illustrate waveforms of the driving voltage signal Vd.

FIG. 10 is a block diagram of a driving circuit for a light source according to a third exemplary embodiment of the present invention.

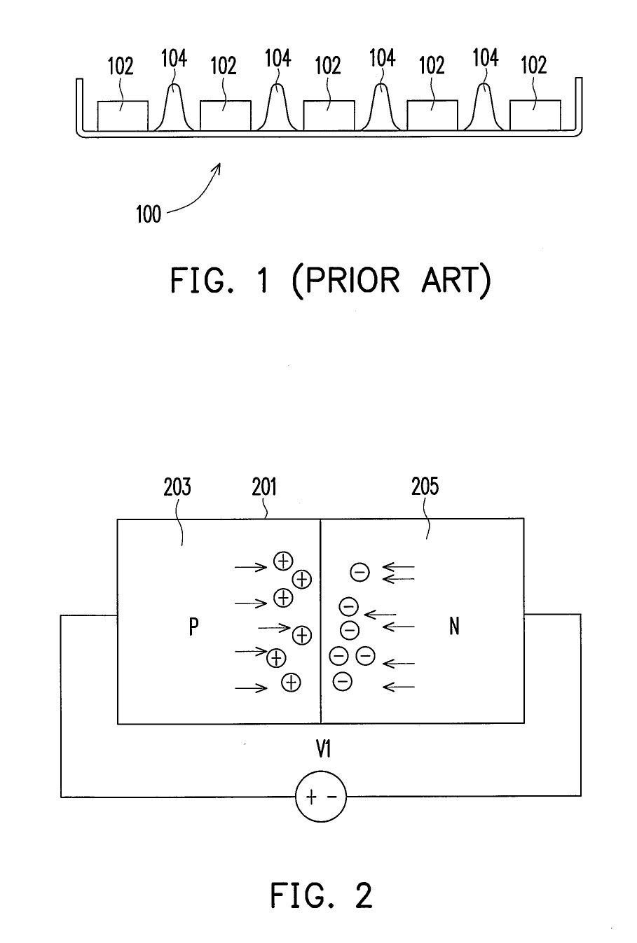

### DESCRIPTION OF EMBODIMENTS

Referring to FIG. 2, a light emitting diode (LED) is a semiconductor with PN junction and it emits light when it is supplied with a forward bias. As shown in FIG. 2, the LED 201 has a P-region 203 and an N-region 205. When a DC forward bias V1 is supplied to the LED 201, holes in P-region 203 and electrons in N-region 205 move towards the PN junction and re-combine randomly, and at this time, energy is released. The description above shows the light emitting theory of LED.

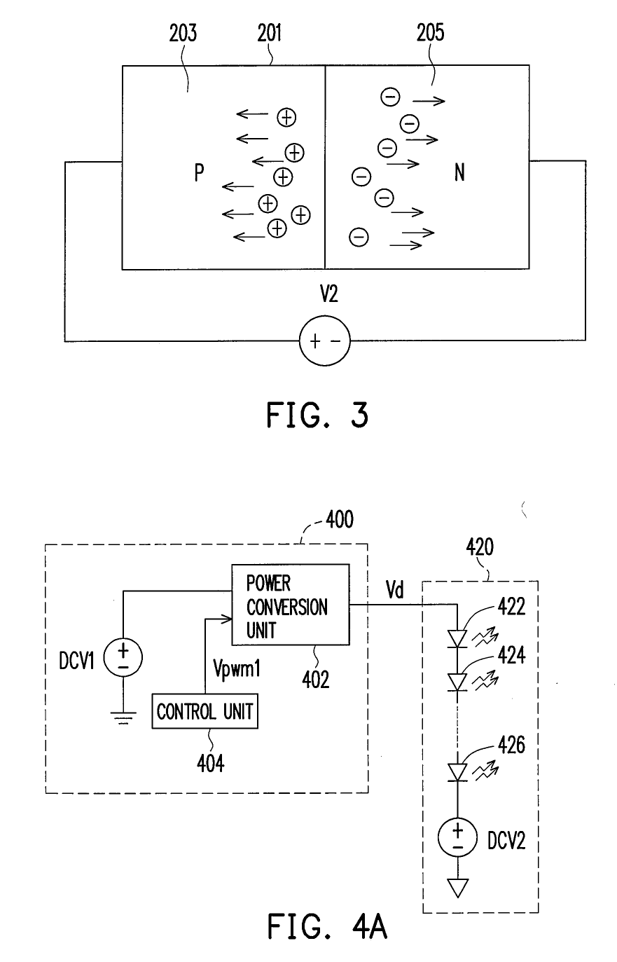

When a LED is working, since energy is released due to re-combination of electrons and holes, the temperature at the PN junction of the LED increases. On the other hand, when the LED is working under a reversed bias, as shown in FIG. 3, a reversed bias V2 is supplied to the LED 201, holes in P-region 203 and electrons in N-region 205 leave the PN junction and move towards two ends of the LED 201. The heat energy at the PN junction of the LED is carried to the two ends of the LED through the movement of the holes and electrons. Accordingly, the foregoing theories are used by the present invention for accomplishing the purpose of LED heat dissipation.

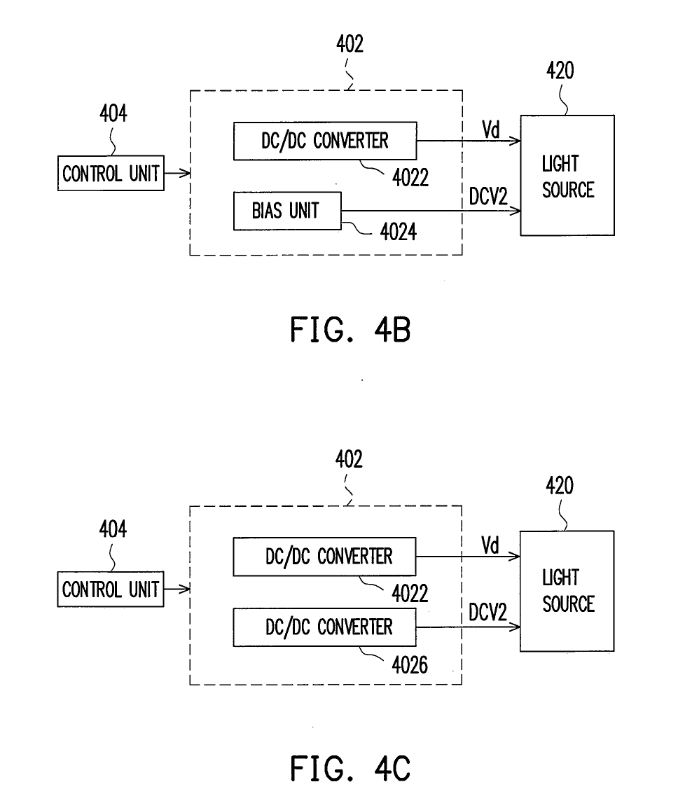

FIG. 4A is a block diagram of a driving circuit 400 for a light source according to the first exemplary embodiment of the present invention. The driving circuit 400 is suitable for driving a light source 420 having a plurality of LEDs (such as 422, 424, . . . , 426). In the present embodiment, the driving circuit 400 includes a power conversion unit 402 and a control unit 404. The power conversion unit 402 may be a buck-boost circuit which receives the output of the control unit 404 and a power supply DCV1 and controls the light source 420 according to the output of the control unit 404.

In the present embodiment, the control unit 404 may be a pulse width modulation (PWM) unit for generating a PWM signal Vpwm1 to be sent to the power conversion unit 402. Accordingly, the power conversion unit 402 generates a driving voltage signal Vd of different levels for controlling the operation of the light source 420 to be forward bias operation or reversed bias operation according to the duty cycle of PWM signal Vpwm1.

Moreover, LEDs 422, 424, . . . , 426 in the light source 420 may be connected in series. In the present embodiment, the cathode of each LED is coupled to the anode of the next LED. Wherein the anode of the first LED 422 receives the driving voltage signal Vd output by the power conversion unit 402, and the cathode of the last LED is coupled to a DC bias DCV2.

In some other embodiments, LEDs 422, 424, . . . , 426 in the light source 420 may be coupled in reversed way, that is, the anode of each LED is coupled to the cathode of the next LED. Wherein the cathode of the first LED receives the driving voltage signal Vd output by the power conversion unit 402, and the anode of the last LED may be grounded or grounded through another bias.

Referring to FIG. 4A again, light source 420 performs forward bias operation when the level of the driving voltage signal Vd is higher than DC bias DCV2. On the other hand, the light source 420 performs reversed bias operation when the level of the driving voltage signal Vd is lower than DC bias DCV2. In some other embodiments, the cathode of the last LED in the light source 420 may also be grounded, thus, when the driving voltage signal Vd is a negative voltage level, the light source 420 also performs reversed bias operation.

FIGS. 4B and 4C are block diagrams illustrating the internal circuit of the power conversion unit 402 according to the first exemplary embodiment of the present invention. In FIG. 4A, the power conversion unit 402 may include a DC/DC converter 4022 in FIG. 4B and a bias unit 4024. The DC/DC converter 4022 generates the driving voltage signal Vd to be sent to the light source 420 according to the output of the control unit 404, and the bias unit 4024 outputs the bias DCV2 to the light source 420.

In FIG. 4C, the bias unit 4024 in FIG. 4B is replaced with a DC/DC converter 4026. Like the bias unit 4024, the DC/DC converter 4026 generates the bias DCV2 to be sent to the light source 420 according to the output of the control unit 404.

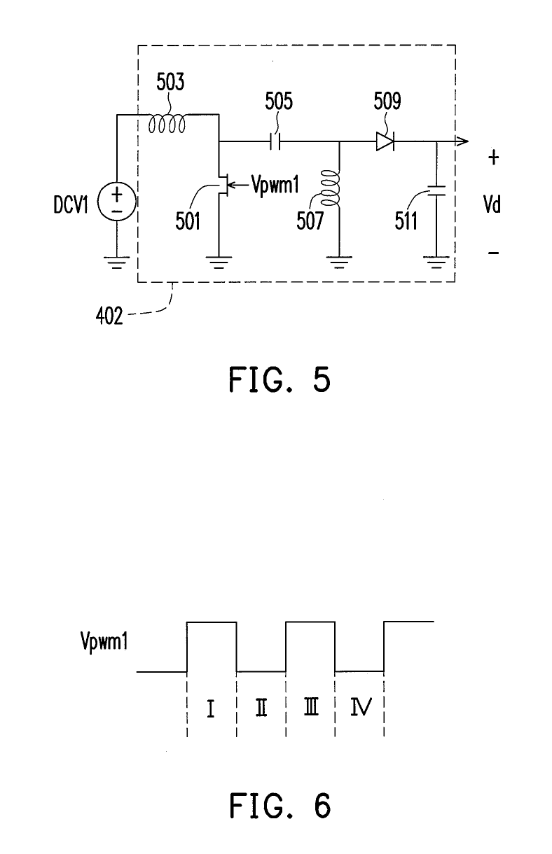

FIG. 5 is a circuit diagram of a power conversion unit according to the first exemplary embodiment of the present invention. Referring to FIG. 5, the power conversion unit 402 includes a switch component 501, inductors 503 and 507, capacitors 505 and 511, and a diode 509.

In the present embodiment, the switch component 501 may be implemented with a NMOS transistor having its first source/drain grounded, its gate receiving the PWM signal Vpwm1, and its second source/drain coupled to the power supply DCV1 through the inductor 503.

The second source/drain of the switch component 501 is coupled to one terminal of the capacitor 505, and the other terminal of the capacitor 505 is grounded through the inductor 507 and coupled to the anode of the diode 509. Besides, the cathode of diode 509 is grounded through the capacitor 511.

FIG. 6 is a timing diagram of the PWM signal Vpwm1 required by the power conversion unit 402 in FIG. 5 for generating a driving voltage signal. Referring to both FIG. 5 and FIG. 6, when the PWM signal Vpwm1 is enabled during period I, the switch component 501 is then turned on. Here the power supply DCV1 supplies a current to pass through the inductor 503 and the switch component 501 so that the inductor 503 starts to store up energy.

The PWM signal Vpwm1 is disabled during period II so that the switch component 501 is turned off. Here the current supplied by the power supply DCV1 and the current stored in the inductor 503 charge the capacitor 505.

The PWM signal Vpwm1 is enabled again during period III so that the switch component 501 is turned on. Here the capacitor 505 starts to discharge, so that the inductor 507 starts to store up energy.

The PWM signal Vpwm1 is disabled again during period IV so that the switch component 501 is switched off. Here the current supplied by the power supply DCV1 and the current stored in the inductor 503 charge the capacitor 511, meanwhile, the inductor 507 also starts to charge the capacitor 511. Accordingly, the power conversion unit 402 can generate stable driving voltage signal Vd.

As described above, the ratio of the driving voltage signal Vd to the voltage output by the power supply DCV1 is related to the duty cycle of the PWM signal Vpwm1. In the present embodiment, the ratio of the driving voltage signal Vd to the voltage output by the power supply DCV1 can be expressed with following expression:

$$\frac{{V}_{O}}{{V}_{I}} = \frac{D}{1 - D} \qquad ( 1 )$$

Wherein V_{O} represents the output voltage, namely, the driving voltage signal Vd, V_{I} represents the input voltage, namely, the DC bias provided by the power supply DCV1, and D represents the duty cycle of the PWM signal Vpwm1.

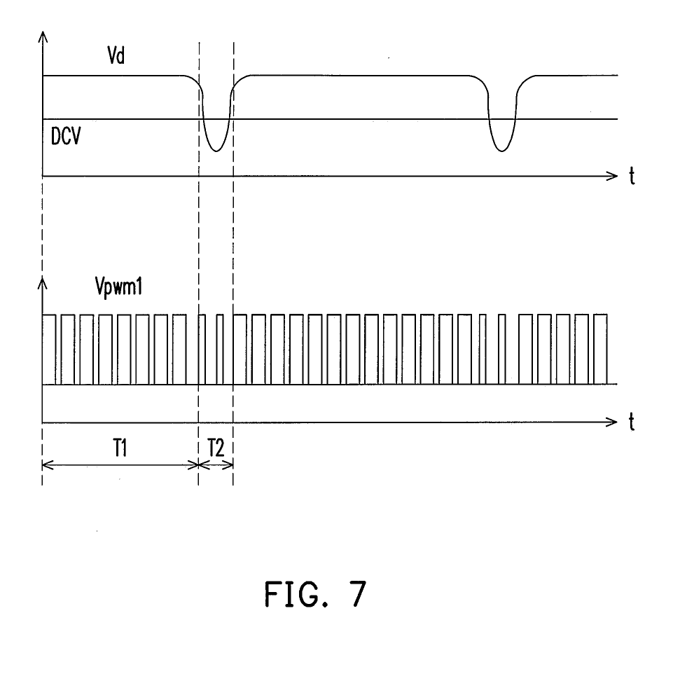

FIG. 7 is a timing diagram of PWM signal and driving voltage signal. It can be understood from FIG. 7 that since the duty cycle of the PWM signal Vpwm1 is more than 50% (referred to as the first duty cycle) during time period T1, and according to foregoing expression (1), the driving voltage signal Vd has higher level. On the other hand, since the duty cycle of the PWM signal Vpwm1 is less than 50% (referred to as the second duty cycle) during time period T2, the driving voltage signal Vd is switched to a lower level. Thus, in the present invention, the driving voltage signal Vd can be controlled, and accordingly the light source can be controlled to perform forward bias operation or reversed bias operation, by adjusting the duty cycle of the PWM signal Vpwm1.

More specifically, referring to FIG. 4A, when the driving voltage signal Vd is at a higher level and is greater than the bias provided by the power supply DCV2, the light source 420 operates under forward bias. On the other hand, when the driving voltage signal Vd is at a lower level and is smaller than the bias provided by the power supply DCV2, the light source 420 operates under reversed bias.

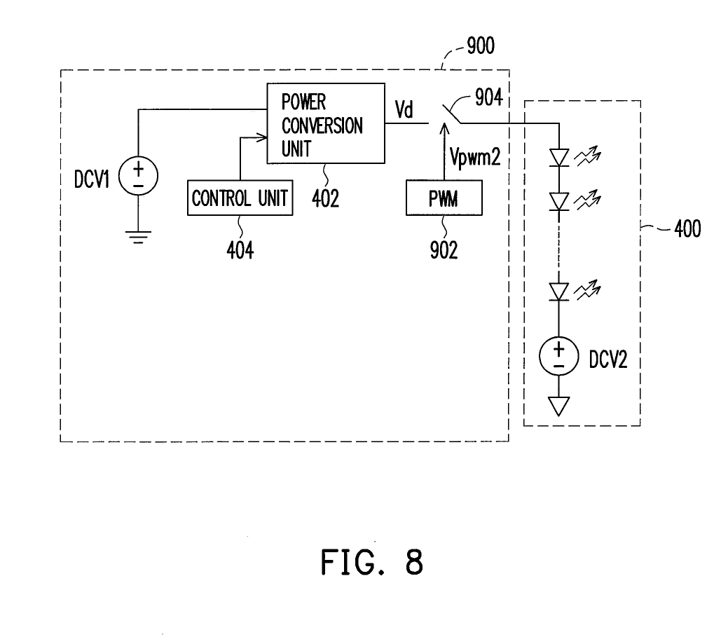

FIG. 8 is a block diagram of a driving circuit for a light source according to the second exemplary embodiment of the present invention. Referring to FIG. 8, those functional blocks having the same reference numerals or the same titles perform likely as those in FIG. 4A. The difference of the present embodiment from the first embodiment is that the driving circuit 900 in the present embodiment further includes a PWM unit 902 and a switch 904.

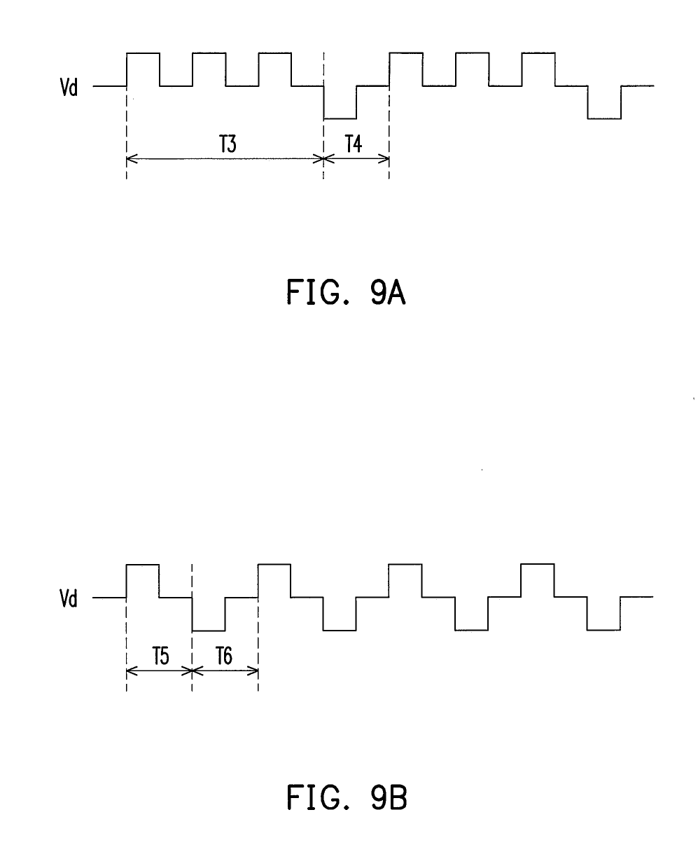

Referring to FIG. 8, the switch 904 is disposed between the power conversion unit 402 and the light source 420 and determines whether to send the driving voltage signal Vd generated by the power conversion unit 402 to the light source 420 according to the signal Vpwm2 generated by the PWM unit 902. In the present embodiment, the signal Vpwm2 generated by the PWM unit 902 is used for adjusting the brightness of the light source 420. Thus, an adjusted driving voltage signal Vd can be output by adjusting the duty cycle of the PWM signal Vpwm2 (as shown in FIG. 9A), so as to adjust the brightness of the light source 420. In addition, when the driving voltage signal Vd is disabled, the power supply controls the light source 420 to perform reversed bias operation, so as to accomplish heat dissipation.

FIGS. 9A and 9B illustrate waveforms of the adjusted driving voltage signal Vd. Referring to FIG. 9A first, during time period T3, a driving voltage signal Vd with square waves having peaks at a higher level is generated. Here the light source 420 in FIG. 4A can operate under forward bias. While during time period T4, a driving voltage signal Vd with square waves having peaks at lower level is generated, so that the light source 420 in FIG. 4A operates under reversed bias. In the present embodiment, the time period T3 is longer than the time period T4. In other words, the light source 420 may perform heat dissipation after it has operated for a while.

Referring to FIG. 9B, the major difference of the waveform in FIG. 9B from that in FIG. 9A is that the lengths of time periods T5 and T6 are the same. That is, the time of the light source operated under forward bias and reversed bias are the same, and such circuit is suitable for a high-speed system which has high demand to heat dissipation.

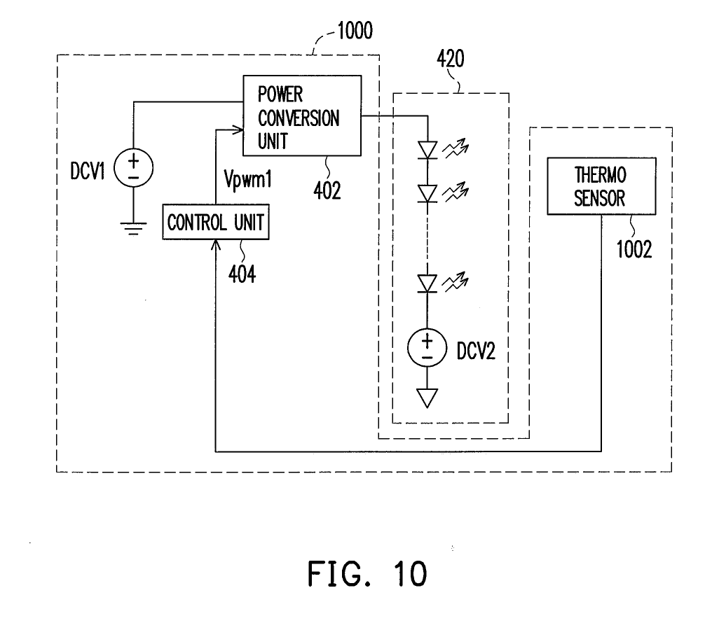

FIG. 10 is a block diagram of a driving circuit for a light source according to the third exemplary embodiment of the present invention. Referring to FIG. 10, the functional blocks having the same reference numerals or titles perform likely as those in FIG. 4A. The difference of the driving circuit 1000 in the present embodiment from that in the first embodiment is that the driving circuit 1000 further includes a thermo sensor 1002 for detecting the operation temperature of the light source 420. When the operation temperature of the light source 420 exceeds a predetermined value, the thermo sensor 1002 generates a detection signal to the control unit 404, and when the control unit 404 receives the detection signal, the control unit 404 adjusts the duty cycle of the PWM signal Vpwm1 sent to the power conversion unit 402, for example, the control unit 404 reduces the duty cycle of the PWM signal Vpwm1.

The power conversion unit 402 is controlled to generate a driving voltage Vd which changes along time (as shown in FIG. 7) so that the light source 420 performs reversed bias operation and forward bias operation alternatively along time, so as to accomplish heat dissipation.

In summary, in the present invention, the operation of a LED can be controlled to be forward bias operation or reversed bias operation during different time periods, thus, heat dissipation can be performed to the light source effectively without any additional hardware.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A driving circuit for a light source comprising at least one light emitting diode (LED), the driving circuit comprising:
a first pulse width modulation (PWM) unit, for generating a first PWM signal whose duty cycle is variable; and
a power conversion unit, for generating a driving voltage signal for controlling the light source to perform a forward bias operation or a reversed bias operation according to the first PWM signal,
wherein the light source is controlled to perform the reversed bias operation for heat dissipation.

2. The driving circuit as claimed in claim 1, wherein the duty cycle of the first PWM signal is a first duty cycle when the light source performs forward bias operation, and the duty cycle of the first PWM signal is a second duty cycle when the light source performs reversed bias operation.

3. The driving circuit as claimed in claim 1, wherein the cathode of the LED is grounded through a second power supply, and the second power supply provides a second voltage signal.

4. The driving circuit as claimed in claim 3, further comprising a second PWM unit for generating a second PWM signal to determine whether or not to send out the driving voltage signal for adjusting a brightness of the light source, and when the driving voltage signal is not sent out, the second voltage signal controlling the light source performs the reversed bias operation.

5. The driving circuit as claimed in claim 1, wherein the anode of the LED is grounded through a third power supply, and the third power supply provides a third voltage signal.

6. The driving circuit as claimed in claim 5, further comprising a second PWM unit for generating a second PWM signal to determine whether or not to send out the driving voltage signal for adjusting a brightness of the light source, and when the driving voltage signal is not sent out, the third voltage signal controlling the light source performs the reversed bias operation.

7. The driving circuit as claimed in claim 1, further comprising:
a switch, disposed between the power conversion unit and the light source; and
a second PWM unit, for generating a second PWM signal to determine an on/off status of the switch so as to adjust a brightness of the light source.

8. The driving circuit as claimed in claim 1, further comprising a thermo sensor for detecting the operation temperature of the light source, wherein when the operation temperature of the light source exceeds a predetermined value, the thermo sensor generates a detection signal, the first PWM unit adjusts the duty cycle of the first PWM signal according to the detection signal to allow the driving voltage signal to change along time to make the light source perform a reversed bias operation and a forward bias operation alternatively along time.

9. The driving circuit as claimed in claim 1, wherein the power conversion unit comprises:
a switch component, receiving the first PWM signal;
a first inductor, having one terminal receiving a DC bias and another terminal coupled to the switch component;
a second inductor;
a first capacitor, having one terminal coupled to the switch component and another terminal grounded through the second inductor;
a diode, having its anode coupled to a terminal of the first capacitor and grounded through the second inductor; and
a second capacitor, having one terminal coupled to the cathode of the diode and another terminal grounded.

10. The driving circuit as claimed in claim 9, wherein the switch component is a transistor, the first source/drain of the switch component is grounded, and the gate of the switch component receives the first PWM signal.

11. The driving circuit as claimed in claim 1, wherein the power conversion unit is a buck-boost circuit.

12. The driving circuit as claimed in claim 11, wherein the light source performs a forward bias operation when the duty cycle of the PWM signal generated by the PWM unit is more than 50%.

13. The driving circuit as claimed in claim 11, wherein the light source performs a reversed bias operation when the duty cycle of the PWM signal generated by the PWM unit is less than 50%.

14. A driving method for a light source, wherein the light source comprises at least one LED, and the driving method comprises:
controlling the LED to perform a forward bias operation during a first time period, so that the light source operating normally; and
controlling the LED to perform a reversed bias operation during a second time period for heat dissipation.

15. The driving method as claimed in claim 14, further comprising:
generating a PWM signal whose duty cycle is variable;
controlling the PWM signal into a first predetermined duty cycle during the first time period to generate a driving voltage signal at a first level for driving the light source, and
controlling the duty cycle of the PWM signal into a second predetermined duty cycle during the second time period to generate the driving voltage signal at a second level for driving the light source, wherein the second level is lower than the first level.

16. The driving method as claimed in claim 15, further comprising adjusting the duty cycle of the PWM signal when the operation temperature of the light source exceeds a predetermined value.

17. The driving method as claimed in claim 14, wherein the first time period is longer than or equal to the second time period.

18. The driving method as claimed in claim 14, further comprising:
providing a PWM signal whose duty cycle is variable;
controlling the duty cycle of the PWM signal to be more than 50% during the first time period to generate a driving voltage signal at a first level for driving the light source; and
controlling the duty cycle of the PWM signal to be less than 50% during the second time period to generate the driving voltage signal at a second level for driving the light source, wherein the second level is lower than the first level.

19. A LED driving circuit, comprising:
a power conversion unit, coupled to a input voltage, for converting the input voltage into an output voltage for driving a LED module according to a control signal; and
a control unit, for generating the control signal for controlling the LED module to perform forward bias operation and reversed bias operation alternately
wherein the LED module is controlled to perform the reversed bias operation for heat dissipation.

20. The LED driving circuit as claimed in claim 19, wherein the power conversion unit comprises a DC/DC converter and a bias module, the DC/DC converter is coupled to a first terminal of the LED module, and the bias module is coupled to a second terminal of the LED module.

21. The LED driving circuit as claimed in claim 19, wherein the power conversion unit comprises two DC/DC converters, one of the two DC/DC converters is coupled to a first terminal of the LED module, and another one of the two DC/DC converters is coupled to a second terminal of the LED module.
